(19) United States
(12) Patent Application Publication
(10) Pub. No.: US 2004/0034523 A1
(43) Pub. Date: Feb. 19, 2004

(54) Divided multimedia page and method and system for learning language using the page

(76) Inventor: Sang-Jong Han, Chun chong (KR)

Correspondence Address: Bruce H Troxell, Troxell Law Office, Suite 1404, 5205 Leesburg Pike, Falls Church, VA, 22041, US

(21) Appl. No.: 10/332,235

(22) PCT Filed: Jul. 4, 2001
(86) PCT No.: PCT/KR01/01141

(30) Foreign Application Priority Data
Jul. 6, 2000 (KR) 200038483
Jun. 15, 2001 (KR) 20012200
Jun. 29, 2001 (KR) 200138010

(51) Int. Cl. G06F 17/20

(52) U.S. Cl. 704/8

(57) ABSTRACT

Disclosed is a divided multimedia page which can remove inconvenience that a learner should change a page by himself/herself and enable the learner to learn a foreign language in various types using various learning information provided from a plurality of frames by realizing a single web page with a plurality of frames which output interlinked data, respectively and simultaneously outputting the respective data to the respective frames based on predetermined functions of a mouse cursor. The present invention has an advantage of maximizing language learning effect by allowing the learner to learn the foreign language, which is wanted to be learned, by using the divided multimedia page of the present invention by elements of a language and providing a native speaker's pronunciation and an image with respect to each element, and has further advantage of enhancing learning effect and achieving effective language learning by learning the foreign language through a learner's language-centered language learning method.

### TECHNICAL FIELD

The present invention relates to a method for learning a language through Internet or visual communication, and more particularly, a divided multimedia page, and a method and system for learning a language using the page, which can realize a plurality of frames outputting interlinked data on a single divided page and allow a user to learn a language in various types in the plurality of frames without changing a web page.

### BACKGROUND ART

There have been suggested many methods for learning languages through Internet or visual communication. The language learning methods provide words, sentences, and grammars with respect to the languages to be learned, and in particular cases, pronunciation of native speakers with respect to the words or the sentences in an attempt to improve listening skills of the languages. For instance, foreign language learning methods are typically proceeded with in a manner that a user listens to or sees the words or the sentences in English in advance, and then listens to corresponding explanation in Korean.

However, when the foreign languages are interpreted into learner's languages by words or sentences or long sentences are repeated, the users listen to them without understanding them, thereby deteriorating learning effect and being easily bored. If the users comprehend only meaning of the words in dictionary definitions and learn the pronunciation of the words, the users cannot properly use the words when writing an English composition or when talking with foreigners, failing to accomplish the purpose of learning the foreign languages. If the users listen to the long sentences repeatedly without comprehending the meaning of the sentences, the users cannot freely make a composition using the expressions, rather leading to loss of interest in learning the foreign languages. Further, since this learning directly passes from the word unit to the sentence unit with a lack of learning phrases/paragraphs, the meaning of the phrases/paragraphs which are intermediate stages of the composition is not comprehended, resulting in failure of learning the whole text.

In a foreign language-centered learning method, if the users first listen to or read the foreign languages and then interpret them into learner's languages, the users suffer problems that when listening to the foreign languages, they can not understand and memorize them, and when listening to the learner's languages, they forget the pronunciation of the foreign languages which have already been heard. Although the users comprehend meaning of the learner's languages after the learning, they do not remember the expression or pronunciation of the foreign languages at all. As a result, the learning efficiency is deteriorated in this method.

Furthermore, web pages for language learning which are conventionally provided on Internet are organized in such a manner that once a user selects a predetermined menu on a currently output web page, the current page disappears and a web page which is linked with the currently output page is newly output. If the user wants to see the previous page or a next page, it is only achieved when the user clicks menus such as ‘Backward’, ‘Forward’ or ‘PRE’, ‘NEXT’. Of course, in the conventional art, if one page is composed of a plurality of frames and data within one frame are selected, information related to the data can be output to other frames, and if the user performs a position fixing or a click of a mouse courser, the user can change the page into a new one. However, each page usually provides only one or two functions. In consequence, the conventional method for learning the foreign languages through Internet has a disadvantage that the user should return to the previous page by using the mouse or a key board when he/she wants to learn the page, which has already been studied, causing inconvenience of language learning to the user and deterioration of efficiency in language learning.

### Disclosure of Invention

It is, therefore, an object of the present invention to provide a divided multimedia page, and a method and system for learning a language using the page that substantially obviates one or more problems due to limitations and disadvantages of the related art thread-tension.

To achieve the object, there is provided a method for learning a foreign language using a communication network including a web server storing plural types of language learning data which are interlinked with one another and a terminal having input/output units, wherein a learning page on which the learning data are output, being composed of a plurality of independent frames, is a divided multimedia page which outputs discretionary data among the plural types of learning data and relational data interlinked with the discretionary data to the respective corresponding frames, and when discretionary learning data within one frame among the plurality of frames are selected through one selection method among a plurality of selection methods, the relational plural types of learning data are simultaneously output to the respective corresponding frames according to the selection method, wherein the learning data are stored in a learner's language and a foreign language, respectively, and the learning data stored in the learner's language and the foreign language are stored in word data, phrase/paragraph data and sentence data, respectively, the language learning method comprising the steps of connecting to a web page of an operator of a language learning system; selecting a learning menu and outputting a learning page with respect to the selected learning menu; designating either of the learner's language and the foreign language, outputting the learning data in the designated language to a frame within the learning page, designating one among a word unit, a phrase/paragraph unit, and a sentence unit with respect to the output learning data and learning the foreign language in the designated language; and terminating the learning by selecting a learning termination button by a learner.

To achieve the above object, there is provided a system for learning a language using a communication network, the system comprising a web server storing plural types of language learning data which are interlinked with one another and a terminal having input/output units, wherein a web page being output to the terminal and being composed of a plurality of independent frames, is a divided multimedia page which simultaneously outputs discretionary data among the plural types learning data and relational data interlinked with the discretionary data to the respective frames; wherein the input unit has a plurality of selection methods including a first selection method in which when discretionary character learning data within a first frame among the plurality of frames are selected, relational data interlinked with the selected data are output to the respective corresponding frames and a small window is generated right below the selected data to output an interpretation message with regard to the selected data to the small window, a second selection method in which voice data interlinked with the selected data are output through a voice output unit, a third selection method in which contents output within at least one frame is preserved and a fourth selection method in which if discretionary learning data among the preserved contents are selected by the second selection method, the voice data interlinked with the selected data are output through the voice output unit; wherein the learning data are stored in a learner's language and a foreign language, respectively, and the learning data stored in the learner's language and the foreign language are stored in word data, phrase/paragraph data and sentence data, respectively; wherein if either of the learner's language and the foreign language is designated by a learner, the learning data are output to a first frame in the designated language and if one among a word unit, a phrase/paragraph unit and a sentence unit is designated by the learner, when the learning data within the first frame are selected by the first to the third selection methods, the learning data are selected in the designated unit.

To achieve the above object, there is provided a system for learning a language using a communication network, the system comprising a web server storing a plural types of learning data interlinked with one another and a terminal having input/output units, wherein a learning page being output to the terminal and being composed of a plurality of independent frames is a divided multimedia page which simultaneously outputs discretionary data among the plural types of learning data and relational data interlinked with the discretionary data to the respective corresponding frames; wherein character learning data corresponding to moving picture learning data output to a second frame are output to a first frame among the plurality of frames; wherein the input unit has a first selection method in which when discretionary character learning data are within the first frame are selected, relational character data interlinked with the selected data are simultaneously output to the respective corresponding frames at the same time when a small window is generated right below the selected data and an interpretation message with regard to the selected data is output to the small window, and a second selection method in which contents output within at least one frame is preserved; wherein the learning data are stored in a learner's language and a foreign language, respectively, and the learning data stored in the learner's language and the foreign language are stored in word data, phrase/paragraph data and sentence data, respectively; wherein if either of the learner's language and the foreign language is designated by a learner, the learning data are output to the first frame, and if one among a word unit, a phrase/paragraph unit and a sentence unit is designated by the learner, when the learning data within the first frame are selected by the first or the second selection method, the learning data are selected in the designated unit.

To achieve the above object, there is provided a divided multimedia page comprising a plurality of independent frames, wherein each of the frames is provided to a web server which has a plurality of data bases composed of contents, respectively, and if discretionary data output to one frame among the frames are selected, the discretionary data and data interlinked with the discretionary data are extracted from the data bases and output to the respective corresponding frames, wherein the data bases include a first block data base which includes a foreign language word data base for storing a word of the foreign language, a learner's language word data base for interpreting the word of the foreign language, a foreign language word pronunciation data base for storing a native speaker's pronunciation of the word of the foreign language, and a learner language word pronunciation data base for storing a native speaker's pronunciation of a word of the learner's language; a second block data base which includes a foreign language phrase/paragraph data base for storing a phrase/paragraph of the-foreign language, a learner's language phrase/paragraph data base for interpreting the phrase/phase of the foreign language, a foreign language phrase/paragraph pronunciation data base for storing a native speaker's pronunciation of the phrase/paragraph of the foreign language, and a learner's language phrase/paragraph pronunciation data base for storing a native speaker's pronunciation of a phrase/paragraph of the learner's language; a third block data base which includes a foreign language sentence data base for storing a sentence of the foreign language, a learner's language sentence data base for interpreting the sentence of the foreign language, a foreign language sentence pronunciation data base for storing a native speaker's pronunciation of the sentence of the foreign language, and a learner's language sentence pronunciation data base for storing a native speaker's pronunciation of a sentence of the learner's language; and a fourth block data base which stores support data for improving learning effect of the contents stored in the first, the second and the third block data bases.

### BRIEF DESCRIPTION OF THE DRAWINGS

Further objects and advantages of the invention can be more fully understood from the following detailed description taken in conjunction with the accompanying drawings, in which:

FIG. 1 is a block diagram illustrating an entire constitution of a divided multimedia page and a language learning method using the page according to the present invention;

FIG. 2 is a view illustrating a preferred embodiment of the divided multimedia page according to the present invention;

FIG. 3 is a flow chart illustrating the language learning method according to the present invention;

FIG. 4 is a view illustrating another preferred embodiment of the divided multimedia page according to the present invention; and

FIG. 5 is a view illustrating further another preferred embodiment of the divided multimedia page according to the present invention.

### BEST MODE FOR CARRYING OUT THE INVENTION

The aforementioned object, features and advantages will be clearly shown through the following detailed explanation of best modes with reference to accompanying drawings. In explanation of the present invention, detailed description of relational well-known technology would be left out if it is determined to make essential points of the present invention unnecessarily obscure. The present invention will now be described in connection with preferred embodiments with reference to the accompanying drawings.

Initially, as for terms used in the description, a web page composed of a plurality of frames is defined as a ‘divided page’, and a page on which various types data including characters, sounds and images are output is defined as a ‘divided multimedia page’.

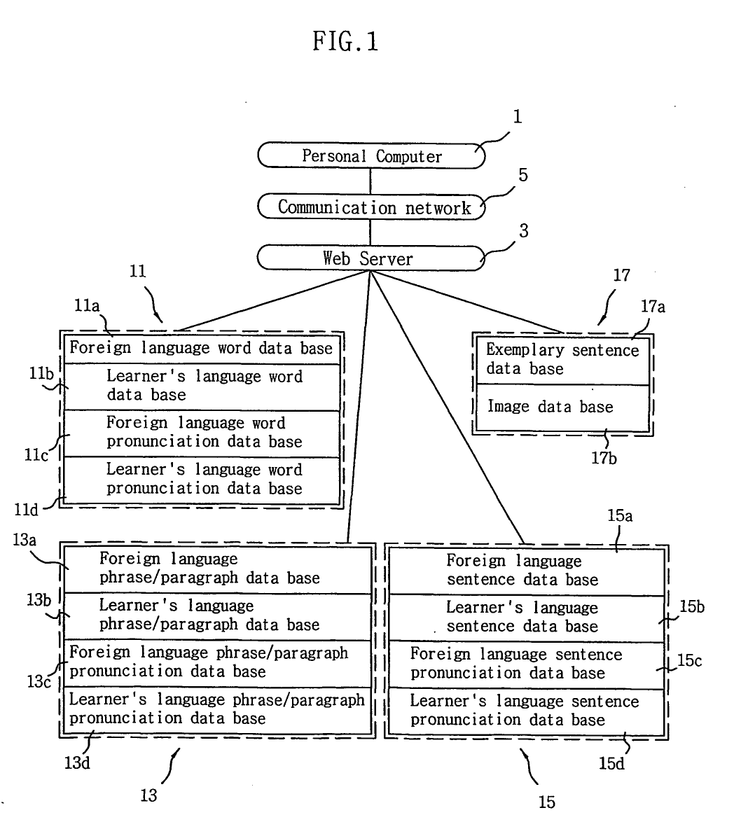

FIG. 1 is a block diagram illustrating a divided multimedia page and a language learning method using the page according to the present invention. A network 5 of the present invention may be a network which is generally used like Internet, and serves to connect a terminal which a language learner, e.g., a personal computer 1 uses to a web server 3 which a system operator operates, so as to transfer data between them. The web server 3 includes a data base and a data base operating system (not shown) which operates the data base.

In a preferred embodiment of the present invention, the data base comprises four blocks 11, 13, 15 and 17 as shown in FIG. 1. A first block 11 comprises a ‘foreign language word data base’ 11a for storing a word of a foreign language, a ‘learner's language word data base’ 11b for interpreting the word of the foreign language in a learner's language, a ‘foreign language word pronunciation data base’ 11c for storing a native speaker's pronunciation of the word of the foreign language which becomes data and a ‘learner's language word pronunciation data base’ 11d for storing a native speaker's pronunciation of the word of the learner's language. Here, the learner's language means a native language of a learner who wants to learn the foreign language by using the language learning method of the present invention. In the preferred embodiment, the learner's language is Korean. The foreign language is a foreign language which the learner wants to learn through the language learning method of the present invention. In the preferred embodiment of the present invention, the foreign language is English.

A second block 13 of the data base comprises a ‘foreign language phrase/paragraph data base’ 13a for storing a phrase/paragraph of the foreign language, a ‘learner's language phrase/paragraph data base’ 13b for storing a phrase/paragraph of the learner's language obtained after interpreting the phrase/paragraph of the foreign language, a ‘foreign language phrase/paragraph pronunciation data base’ 13c for storing a native speaker's pronunciation of the phrase/paragraph of the foreign language which becomes data, and a ‘learner's language phrase/paragraph pronunciation data base’ 13d for storing a native speaker's pronunciation of a phrase/paragraph of the learner's language.

A third block 15 of the data base comprises a ‘foreign language sentence data base’ 15a for storing a sentence of the foreign language, a ‘learner's language sentence data base’ 15b for interpreting the sentence of the foreign language, a ‘foreign language sentence pronunciation data base’ 15c for storing a native speaker's pronunciation of a sentence of the learner's language and a ‘learner's language sentence pronunciation data base’ 15d for storing a native speaker's pronunciation of the sentence of the learner's language.

A forth block 17 comprises an ‘exemplary sentence data base’ 17a and an ‘image data base’ 17b. The exemplary sentence data base 17a provides various types of exemplary sentences in which the selected word is used and the image data base 17b provides an image with regard to the selected word, namely, a picture, a moving picture, a flash or the likes, so as for the learner to easily learn the foreign language. In particular, the first block data base 17 is a place where various types support data are stored to improve learning effect of the contents stored in the first, the second and the third block data bases. As a result, the first block data base 17 can store data having various kinds of contents including contents which coincides with demands of the learner or which the system operator wants to support for efficient learning. Accordingly, the exemplary sentence and image data bases are not limited to the exemplary sentence and image data bases 17a and 17b illustrated in FIG. 1 but may be any one which can store required various types data, such as characters, sounds, images, etc., and fierier a number of the exemplary sentence and image data bases may be increased or decreased according to necessity of the system operator.

The respective blocks 11, 13 and 15 are interlinked with the data bases comprised in the respective blocks (for example, the data bases are 11a, 11b, 11c and 11d, in case of the first block 11) and with data of the exemplary sentence and the image data bases comprised in the fourth block 17. That is to say, in case of the first block, a word among words of the foreign language is interlinked with a corresponding word of the learner's language(Korean), a native speaker's pronunciation(English pronunciation) of the word, a native speaker's pronunciation(Korean pronunciation) of the learner's language of the word, exemplary sentences in which the word is used and an image related to the word.

In the data base constructed as above, when the learner requests necessary data by using the personal computer 1, the request is transferred through the network 5 to the web server 3. The web server 3 finds the data base on which the data which the learner requests and data interlined with the data requested by the learner are stored, extracts all relational data and simultaneously transfers all the relational data to the personal computer 1 of the learner through the network 5. Operation of the various data bases, such as data accumulation, update, search, etc., is performed by the known data base management system (not shown).

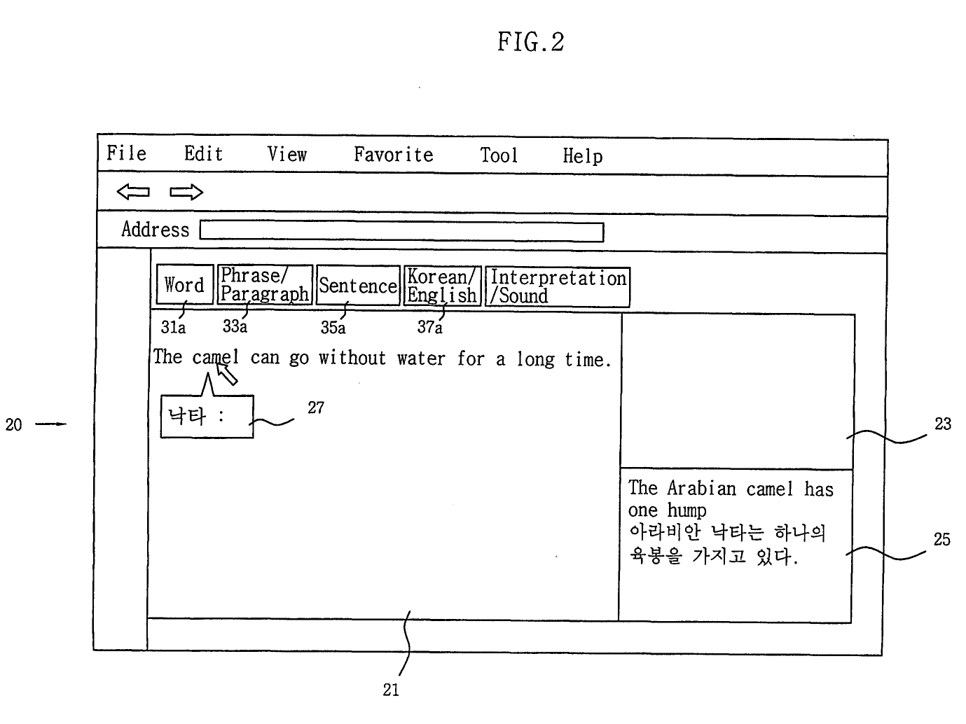

A preferred embodiment of a screen where a picture is realized on an output unit of the personal computer 1 of the learner based on the constitution of the system as shown in FIG. 1 is illustrated in FIG. 2. FIG. 2 shows a preferred embodiment of the divided multimedia page according to the present invention. The divided page 20 according to the present invention comprises a plurality of independent frames 21, 23 and 25 as shown in the drawing. A number of the illustrated frames 21, 23 and 25 is not limited to three but may be increased or decreased according to necessity.

The frame 21 is used to represent a basic sentence, the frame 23 is used to represent an image and the frame 25 is used to represent exemplary sentences. In the respective frames constructed as above, the basic sentence, the image and the exemplary sentences are output to the respective frames in an independent manner, and as stated above, words, phrase/paragraphs or sentences within the basic sentence, the image and the exemplary sentences are interlinked with one another.

As shown in FIG. 2, under the circumstance that the foreign language is English and the learner's language is Korean, constitution of the multimedia learning page of the present invention will be explained by way of example where the basic sentence with regard to a camel is output in English in the frame 21.

Especially, even though the foreign language is English and the learner's language interpreting the foreign language(English) is Korean in FIG.2, the learner's language interpreting the foreign language may be varied according to languages of learners who learn the foreign language. That is, if the foreign language is English, the foreign language may be interpreted in Japanese or Russian according to the learner's language.

If the learner puts a mouse cursor on a specific word, for example camel, among many words without a click, a signal with respect to the selected word(camel) is transferred to the web server 3 through the network 5. The web server 3 extracts an interpretation phrase, which is linked with the selected word(camel) among the data bases and includes the word ‘camel’ and a short explanation of the camel, based on the transferred signal from the learner's language word data base 11b and transfers the same through the network 5. The transferred phrase is the interpretation phrase 27 about the selected word(camel) as shown in FIG. 2 and generates a small explanation window right below the word so as to be output. At the same time, an image(camel image) with respect to the selected word(camel) is output in the frame 23 while various exemplary sentences and interpretation of the exemplary sentences about the selected word(camel) are output in English in the frame 25.

Since only the action that the mouse cursor is put on the specific word without any click can allow the interpretation message, the relational image and the relational exemplary sentences concerning the specific word to be simultaneously output to the respective frames within the single divided multimedia page, interpretation concerning the specific word and association with the relational image are achievable, thereby enhancing language learning effect, and the foreign language is learned in various types in the plurality of frames without changing the page of the entire screen by the learner, thereby ensuring efficient learning.

Further, if the learner clicks once the mouse cursor on the selected word(camel), a native speaker's pronunciation of the selected word is output through a voice output unit, for example, a speaker which is connected to the personal computer 1. The user can hear the native speaker's pronunciation of the word repeatedly by clicking the mouse as many as needed. Furthermore, the preferred embodiment may be constructed such that the pronunciation is automatically repeated as many as a predetermined number with one click. The number may be increased or decreased according to necessity of the system operator, or increased or decreased in a manner that the user changes environmental setting of the system.

Moreover, as a substitute embodiment, it is also possible that whenever the learner clicks, the native speaker's pronunciation both of the foreign language and the learner's language with respect to the selected word is output in turn. For example, once the camel is selected and first clicked, English pronunciation is output and then if the camel is clicked once again, Korean pronunciation like

[symbol]

is output, and then if the camel is clicked once more, English pronunciation is output again. In this manner, the embodiment can be constructed to repeatedly output two types of pronunciation in turn. Accordingly, since the learner hears ‘camel’ and

[symbol]

repeatedly, the learner can learn the word in Korean as well as in English in a natural way, resulting in more efficient learning.

Meantime, if the mouse cursor is double clicked on the selected word, contents output to the image frame 23 and the exemplary frame 25 is preserved. That is to say, even if the mouse is double clicked and then is moved to another position, the image and the exemplary sentences with respect to the selected word(camel) are not changed and the function is preserved until the learner cancels the function. The cancellation of the function may be made in a manner that the mouse is put on a discretionary position on the basic sentence frame 21 and clicked. However, the cancellation method may be properly set by the system operator and is not limited to some specific methods. Under this situation that the contents is preserved, the learner can learn the exemplary sentences in more detail through various types of learning methods provided by the present invention. By way of example, when each English word(Arabian) which exists in the exemplary sentence is clicked once, a native speaker's pronunciation of the word may be output. Further, when a Korean word

[symbol]

which exists in the exemplary interpretation sentence within the exemplary sentence frame 25 is clocked once, a native speaker's pronunciation of the English word(Arabian) corresponding to the Korean word may be output.

As stated above, the learner selects the word(camel) which is wanted to be learned in the basic sentence output to the frame 21 and thus can learn simultaneously the interpretation

[symbol]

of the word, the relational image(camel image), and the relational exemplary sentences on the single web page, so that the learner gets to have a chance to associate the word with the relational image and exemplary sentences, thereby improving the language learning effect, and further the learner can concentrate on the native speaker's pronunciation and the exemplary sentences by clicking the mouse once or twice. This is possible by using the divided multimedia page. The multimedia page is characterized in that the respective data within the data bases of the web server are interlinked with one another, the single divided page 20 comprises the plurality of independent frames 21,23 and 25, and the functions of the mouse cursor, such as position fixing, one click or double click and the likes are maximally used. Accordingly, the embodiment has advantages of removing inconvenience that the learner should change each page by himself/herself and improving efficiency in learning the foreign language by permitting the learner to learn the foreign language in various types.

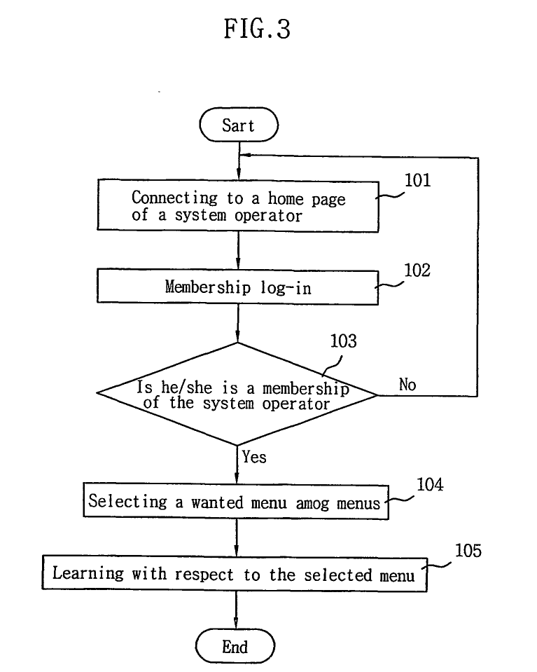

Referring to FIG. 3, a flow chart shows that the language learning method using the divided multimedia page according to the present invention is executed.

The learner outputs an initial screen by connecting to a home page of the system operator at a step 101. The learner logs in by entering membership information, e.g., ID and password on the output initial screen at a step 102. The membership information logged in the step 102 is transferred to the web server 3 of the system operator connected to the communication network through the personal computer 1 and the web server 3 inquires whether the learner is registered based on the transferred membership information at a step 103. As the inquiry result, if the learner is registered on the web server of the system operator, a learning menu page is output on a monitor of the personal computer, whereas if the learner is not registered, the learner has to return to the initial screen.

In this manner, if the learner is confirmed a registered member as the result of the inquiry and the learning menu page is output, the learner selects a learning menu which he/she want to study among the plurality of learning menu items at a step 104. The learning menu items may vary according to the system operator. The contents of the learning menu items may include reading materials, such as English fairy story or English news paper, moving pictures, such as CNN news, drama or movie, writing materials and listening materials.

Additionally, if the learning menu to be learned is selected in the step 104, a page showing particular items with respect to the learning menu may be output. For instance, if the learner selects and clicks English news paper in the learning menu page, there may be output a selection screen inquiring about kinds of the English news paper or issued date of the English news paper. Whether or not the selection screen exists or how icons are arranged on the screen may be selected by the system operator in a discretionary manner.

After passing the above steps, the divided multimedia page 20 on which the learner can perform the learning in connection with the selected menu is output at a step 105. For instance, FIG. 2 shows an example of the divided page when the learner selects a title ‘The Camel’ in ‘English fair story’.

Referring again to FIG. 2, the divided multimedia page 20 includes the frames 21, 23 and 25 on which the basic sentence, the image and the exemplary sentences are independently output, as well as including a word button 31a a phrase/paragraph button 33a and a sentence button 35a which enable the basic sentence output to the basic sentence frame 21 to be learned in various types.

The buttons permit the learner to learn the foreign language by elements of a language, in other words, word by word, phrase/paragraph by phrase/paragraph and sentence by sentence. The learner selects which unit the learner uses to learn the specific basic sentence, among the word unit, the phrase/paragraph unit and the sentence unit by selecting one of the buttons 31a, 33a and 35a. As aforesaid, FIG. 2 shows the example of the divided page when the learner selects the word button 31a with respect to the basic sentence ‘The Camel’. That is, FIG. 2 shows that the interpretation message, the image, the exemplary sentences and the native speaker's pronunciation are provided according to each word. However, if the learner selects the phrase/paragraph button 33a, for example, there are provided an interpretation message, an image, exemplary sentences and a native speaker's pronunciation of the phrase/paragraph. For instance, if the learner puts the mouse cursor on a word(‘time’), an interpretation message

[symbol]

with respect to a phrase/paragraph(‘for a long time’) including the word(‘time’) is provided.

The learner gets to have a chance to gradually learn the foreign language from the short word through the phrase/paragraph, which has intermediate length, up to the long sentence by learning according to the elements. Moreover, the learner gets to have a chance to associate the foreign language with the native speaker's pronunciation and the relational image by the word, the phrase/paragraph, the sentence by using the divided multimedia page. As a consequence, more efficient language learning is ensured and more easy application to writing or speaking is also ensured.

Besides, a Korean/English button 37a may be provided to enable a native language (learner's language)-centered learning. Whenever the Korean/English button 37a is clicked, entire text of the basic sentence frame 21 is converted into English or Korean. In other words, once the button is clicked, a specific basic sentence is viewable in the learner's language as a whole, such that the learner's language-centered learning is available. If the Korean/English button 37a is clicked, the basic sentence is output in Korean on the basic sentence frame 21. Under this circumstance, the learner can use the aforesaid functions of the mouse, such as, position fixing, one click, double click etc. That is to say, if the mouse is positioned without any click on a specific word,

[symbol]

a small explanation window is formed right below the selected word and a foreign language(‘camel’) with respect to the selected word is output inside the small explanation window. At the same time, an image(camel image) with respect to the selected word is output to the frame 23 while various types exemplary sentences and interpretation about each exemplary sentence with regard to the selected word are output to the frame 25. Since the one click and the double click of the mouse are the same as the functions said before, detailed explanation thereof will be left out.

The learner can learn the foreign language in a more familiar way by conducting the learner's language-centered learning by means of the Korean/English button 37a. In other words, in view that the learner comprehends meaning of a word in the learner's language in advance, if the learner memorizes the meaning in the foreign language, the learner can easily remember pronunciation of the word as if he/she learn a new word of the learner's language, and if he/she hears the word in the learner's language in daily lives, a pertinent word in the foreign language occurs to his/her head. Even though the learner hears the word in the foreign language some times later, he/she can readily associate the word with the meaning of the word in the learner's language. This is possible in such a way that the basic sentence output to the frame 21 is converted into the learner's language, and the learner clicks the familiar word and listens to the pertinent pronunciation of the familiar word in the foreign language.

In this manner, the learner learns English in preferable various types by employing the various functions of the stated divided multimedia page at the step 105. If the learning is terminated, the learner selects a termination button (not shown) to finish the learning.

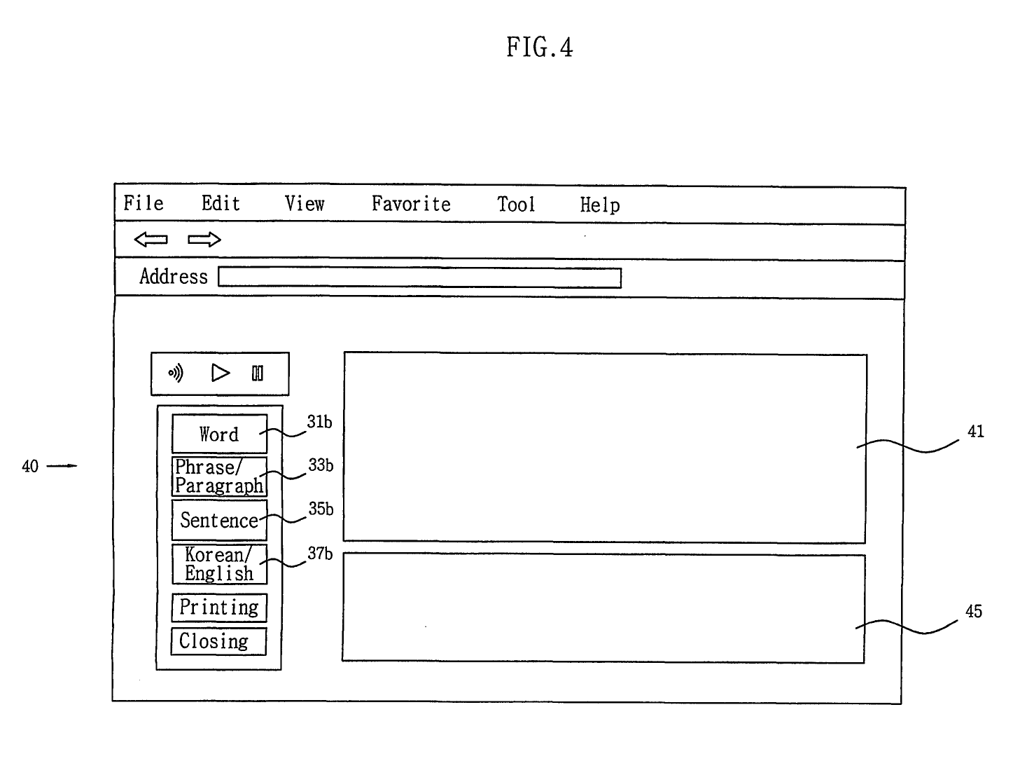

FIG. 4 shows another preferred embodiment of the present invention and illustrates the divided multimedia page when the learner selects ‘English news paper’ as the learning menu at the step 104 of FIG. 3.

According to the another preferred embodiment, the divided multimedia page 40 comprises a frame 41 on which English news reports are output, and a frame 45 on which exemplary sentences with respect to a word or a phrase/paragraph which is selected by means of the mouse cursor are output. A frame on which an image is output is not considered in the another preferred embodiment but it may be added depending on selection of the system operator. It is out of question that arrangement of the respective frames is discretionally changeable according to selection of the system operator. Further, a word button 31b, a phrase/paragraph button 33b, a sentence button 35b and a Korean/English button 37b having the same functions as those described in FIG. 2 are arranged on one side of the divided page 40. Other buttons or icons having additional functions may be added or eliminated according to selection of the system operator.

Furthermore, according to the another preferred embodiment of the present invention, respective data within data bases on which data related to the English news paper of the web server 3 are stored are interlinked with one another and, functions of the mouse cursor, including position fixing, one click, double click and the likes are used, such that an interpretation message, relational exemplary sentences and a native speaker's pronunciation with respect to a discretionary word within the English news paper are simultaneously provided to the respective frames without forwardly or backwardly changing the screen, and a native speaker's pronunciation of a discretionary word within the exemplary sentence may be provided.

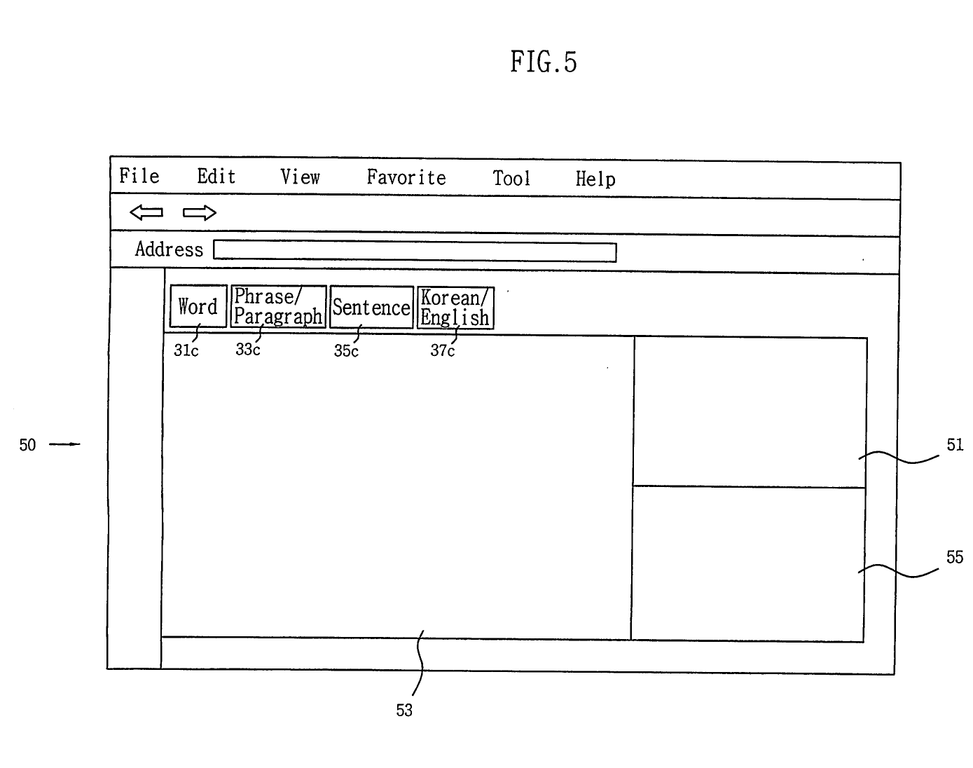

FIG. 5 illustrates further another preferred embodiment of the present invention and the divided multimedia page when a moving picture, such as ‘CNN news’ is selected as the learning menu at the step 104 of FIG. 3.

According to the farther another preferred embodiment, the divided multimedia page 50 comprises a frame 53 on which a moving picture, such as news or movie, is output, a frame 51 on which English speech corresponding to the pertinent moving picture is output, and a frame 55 on which there are output exemplary sentences with respect to a word or a phrase/paragraph which is selected by means of the mouse cursor. Of course, arrangement of the respective frames is variable according to selection of the system operator. A word button 31c, a phrase/paragraph button 33c, a sentence button 35c and a Korean/English button 37c having the same functions as those described with reference to FIG. 2 are arranged on one side of the divided page 50. Other buttons or icons having additional functions may be added or eliminated according to selection of the system operator, similarly to FIG. 2 and FIG. 4.

Moreover, in the further another embodiment, respective data within data bases on which data related to the news or the movie of the web server 3 are interlinked with one another, the respective data are output to the respective frames within the single divided multimedia page, and functions of the mouse cursor, such as position fixing, one click, double click and the likes are used, whereby an interpretation message, relational exemplary sentences and a native speaker's pronunciation of a discretionary word within the English speech in the movie can be simultaneously provided on the respective frames without forwardly or backwardly changing a screen.

### Industrial Applicability

As stated above, the present invention has an advantage of ensuring an efficient and effective language learning, since a plurality of frames outputting interlinked data, respectively, are provided on a single divided page and functions of a mouse cursor, such as position fixing, one click, double click and the likes are maximally used, so that there are realized on the single divided page various types data, such as a word, a phrase/paragraph and a sentence with respect to a foreign language which is wanted to be learned and an image, exemplary sentences, and a native speaker's pronunciation with respect to the word, the phrase/paragraph, and the sentence, etc.

The present invention has another advantage of applying the learning to writing, listening, speaking, or the likes, since the learner can gradually learn the short word through the intermediate length phrase/paragraph up to the long sentence by conducting the language learning by elements of a language. Further, the present invention is capable of effectively learning the foreign language and easily finding application to writing or speaking, since the learning on the divided multimedia page enables the learner to associate the word, the phrase/paragraph and the sentence with a native speaker/s pronunciation and a relational image thereof.

The present invention has still another advantage that the learner can easily memorize pronunciation of a selected word in the foreign language as if he/she learns a new word of the learner's language and when the learner hears the word in the learner's language in daily lives, a corresponding word in the foreign language occurs to his/her head, since a learner's language-centered language learning is carried out. Further, the present invention is capable of permitting the learner to learn the foreign language in an easier way than a foreign language-centered learning method and to learn the foreign language even if the learner does not know letters of the foreign language but only knows letters of the learner's language.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for learning a foreign language using a communication network including a web server storing plural types of language learning data which are interlinked with one another and a terminal having input/output units,
wherein a learning page on which the learning data are output, being composed of a plurality of independent frames, is a divided multimedia page which outputs discretionary data among the plural types of learning data and relational data interlinked with the discretionary data to the respective corresponding frames, and when discretionary learning data within one frame among the plurality of frames are selected through one selection method among a plurality of selection methods, the relational plural types of learning data are simultaneously output to the respective corresponding frames according to the selection method,
wherein the learning data are stored in a learner's language and a foreign language, respectively, and the learning data stored in the learner's language and the foreign language are stored in word data, phrase/paragraph data and sentence data, respectively,
the language learning method comprising the steps of:
connecting to a web page of an operator of a language learning system;
selecting a learning menu and outputting a learning page with respect to the selected learning menu;
designating either of the learner's language and the foreign language, outputting the learning data in the designated language to a frame within the learning page, designating one among a word unit, a phrase/paragraph unit, and a sentence unit with respect to the output learning data and learning the foreign language in the designated language; and
terminating the learning by selecting a learning termination button by a learner.

2. The method of claim 1, wherein the plural types of data includes character data, image data and voice data containing a native speaker's pronunciation of the foreign language and a native speaker's pronunciation of the learner's language.

3. The method of claim 1 or claim 2, wherein the plurality of selection methods includes selection methods carried out by performing position fixing, one click and double click of a mouse cursor.

4. A system for learning a language using a communication network, the system comprising a web server storing plural types of language learning data which are interlinked with one another and a terminal having input/output units,
wherein a web page being output to the terminal and being composed of a plurality of independent frames, is a divided multimedia page which simultaneously outputs discretionary data among the plural types learning data and relational data interlinked with the discretionary data to the respective frames;
wherein the input unit has a plurality of selection methods including
a first selection method in which when discretionary character learning data within a first frame among the plurality of frames are selected, relational data interlinked with the selected data are output to the respective corresponding frames and a small window is generated right below the selected data to output an interpretation message with regard to the selected data to the small window,
a second selection method in which voice data interlinked with the selected data are output through a voice output unit,
a third selection method in which contents output within at least one frame is preserved, and
a fourth selection method in which if discretionary learning data among the preserved contents are selected by the second selection method, the voice data interlinked with the selected data are output through a voice output unit;
wherein the learning data are stored in a learner's language and a foreign language, respectively, and the learning data stored in the learner's language and the foreign language are stored in word data, phrase/paragraph data and sentence data, respectively;
wherein if either of the learner's language and the foreign language is designated by a learner, the learning data are output to a first frame in the designated language and if one among a word unit, a phrase/paragraph unit and a sentence unit is designated by the learner, when the learning data within the first frame are selected by one of the first to the third selection methods, the learning data are selected in the designated unit.

5. The system of claim 4, wherein the voice data output by the second selection method includes a native speaker's pronunciation of the foreign language and a native speaker's pronunciation of the learner's language.

6. The system of claim 4 or claim 5, wherein the first, the second and the third selection methods are carried out by performing position fixing, one click and double click of a mouse cursor.

7. A system for learning a language using a communication network, the system comprising a web server storing a plural types of learning data interlinked with one another and a terminal having input/output units,
wherein a learning page being output to the terminal and being composed of a plurality of independent frames is a divided multimedia page which simultaneously outputs discretionary data among the plural types of learning data and relational data interlinked with the discretionary data to the respective corresponding frames;
wherein character learning data corresponding to moving picture learning data output to a second frame are output to a first frame among the plurality of frames;
wherein the input unit has a first selection method in which when discretionary character learning data are within the first frame are selected, relational character data interlinked with the selected data are simultaneously output to the respective corresponding frames at the same time when a small window is generated right below the selected data and an interpretation message with regard to the selected data is output to the small window, and a second selection method in which contents output within at least one frame is preserved;
wherein the learning data are stored in a learner's language and a foreign language, respectively, and the learning data stored in the learner's language and the foreign language are stored in word data, phrase/paragraph data and sentence data, respectively;
wherein if either of the learner's language and the foreign language is designated by a learner, the learning data are output to the first frame, and if one among a word unit, a phrase/paragraph unit and a sentence unit is designated by the learner, when the learning data within the first frame are selected by the first or the second selection method, the learning data are selected in the designated unit.

8. (deleted)

9. (deleted)
